(19) United States
(12) Patent Application Publication
(10) Pub. No.: US 2018/0167471 A1
(43) Pub. Date: Jun. 14, 2018

(54) METHOD FOR TRACKING PERFORMANCE OF USERS PERFORMING TASKS AND PRESENTING REWARD POINTS

(71) Applicant: Fahed Umar Parkar, Morrisville, NC (US)

(72) Inventor: Fahed Umar Parkar, Morrisville, NC (US)

(21) Appl. No.: 15/373,563

(22) Filed: Dec. 9, 2016

(51) Int. Cl. H04L 29/08; G06Q 10/10

(52) U.S. Cl. CPC H04L 67/22; G06Q 10/1097

(57) ABSTRACT

A system and a method for tracking performance of user performing and rewarding the users upon completion of the tasks are disclosed. The method comprises generating a plurality of tasks by the system. The plurality of tasks is also customizable by a first user. The plurality of tasks or customized tasks is assigned to a plurality of second users. Further, a schedule and reward points for performing each of the plurality of the tasks by one or more second users among the plurality of second users is defined. Subsequently, performance of the plurality of second users in executing the tasks is tracked. The performance is tracked based on the schedule defined in order to assign the reward points to the plurality of second users. The method further comprises converting the reward points into a monetary value.

### FIELD OF INVENTION

The present disclosure relates to a field of tracking performance of users. More specifically, the present disclosure relates to a system and method for tracking performance of user performing and rewarding the users upon completion of the tasks.

### BACKGROUND

As known, tasks are assigned to several users in various domains. For example, tasks are assigned in education, employment and so on. Typically, a person is in charge creates the tasks and assigns each of the tasks to other users. The person assigns the tasks to other users based on their qualification or roles. After assigning the tasks, the person may track status of each project from time to time.

Often, the person does not track the status from time to time due to lack of tracking systems that records status and amount of time spent by each user on the task assigned. Several tracking systems have been proposed in the past to track status of the tasks assigned to the users. However, the tracking systems are complex in nature and are not user friendly. As a result, the users may not use the tracking systems and may procrastinate the tasks assigned.

Therefore, there is a need for a system that can track the performance of the users performing the tasks assigned to the them and should reward them based on the performance of the users. The system should be easy to use, and should be customizable.

### SUMMARY

This summary is provided to introduce concepts related to a system and a method for tracking performance of user performing and rewarding the users upon completion of the tasks and the concepts are further described below in the detailed description. This summary is not intended to identify essential features of the claimed subject matter nor is it intended for use in determining or limiting the scope of the claimed subject matter.

In one example, a method for tracking performance of a plurality of users is disclosed. The method comprises automatically generating a plurality of tasks, by a processor based on the age of a plurality of second users and a first user or receiving, by the processor, the plurality of tasks, optionally customized and assigned to the second set of users by the first user. The method further comprises defining, by the processor, a schedule and reward points for performing each of the plurality of the tasks by one or more second users among the plurality of second users. The method further comprises tracking, by the processor, performance of the plurality of second users in executing the tasks. The performance is tracked based on the schedule defined in order to assign the reward points to the plurality of second users. The method further comprises converting the reward points into a monetary value.

In another example, a system for tracking performance of a plurality of users is disclosed. The system comprises a processor and a memory, coupled to the processor. The memory comprises program instructions to be executed by the processor. The processor executes the program instructions to automatically generate a plurality of tasks or receive the plurality of tasks optionally customized and assigned by the first user to the plurality of second users. The plurality of tasks is generated and assigned to a plurality of second users based on the age of the plurality of the second users and the first user. The processor further executes the program instructions to define a schedule and reward points for performing each of the plurality of the tasks by one or more second users among the plurality of second users. The processor further executes the program instructions to track performance of the plurality of second users in executing the tasks, wherein the performance is tracked based on the schedule defined in order to assign the reward points to the plurality of second users.

In yet another example, a non-transitory computer readable storage medium comprising program instructions which, when executed, are configured to perform a method for tracking performance of a plurality of users is disclosed.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated that the conception and specific embodiment disclosed may be readily utilized as a basis for modifying or designing other structures for carrying out the same purposes of the present disclosure. It should also be realized that such equivalent constructions do not depart from the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF FIGURES

In the following drawings like reference numbers are used to refer to like elements. Although the following figures depict various examples of the invention, the invention is not limited to the examples depicted in the figures.

FIG. 1 illustrates a network implementation of a system for tracking performance of a plurality of users, in accordance with one embodiment of the present disclosure;

FIG. 2 illustrates creating profile of first user and second users, in accordance with one embodiment of the present disclosure;

FIG. 3 illustrates a flowchart for assigning tasks by the system, in accordance with one embodiment of the present disclosure;

FIG. 4 illustrates assigning tasks and defining schedule and reward points to second user, in accordance with another embodiment of the present disclosure;

FIG. 5 illustrates performing tasks and updating the details on the system by the second users, in accordance with one embodiment of the present disclosure;

FIG. 6 illustrates a screenshot of report generated for the tasks assigned, in accordance with one embodiment of the present disclosure; and

FIG. 7 shows a flowchart for tracking performance of a plurality of users, in accordance with one embodiment of the present disclosure.

### DETAILED DESCRIPTION

The following detailed description is intended to provide example implementations to one of ordinary skill in the art, and is not intended to limit the invention to the explicit disclosure, as one of ordinary skill in the art will understand that variations can be substituted that are within the scope of the invention as described. Further, relational terms such as first and second, and the like, may be used to distinguish one entity from the other, without necessarily implying any actual relationship or order between such entities.

The present disclosure relates to a system and a method for tracking performance of a plurality of users is disclosed. At first, a first user assigns a plurality of tasks. The first user assigns the plurality of tasks to a plurality of second users. The first user may include, but not limited to, a father, a parent, a teacher, an employer and so on. The second users may include, but not limited to, a mother, a child, a student, an employee and so on. The tasks may include, but not limited to, chores, health, behavior, assignments, fitness, education and so on. The first user assigns the tasks by defining a schedule for each of the tasks. Subsequently, the first user defines reward points for performing each of the tasks assigned to the second users.

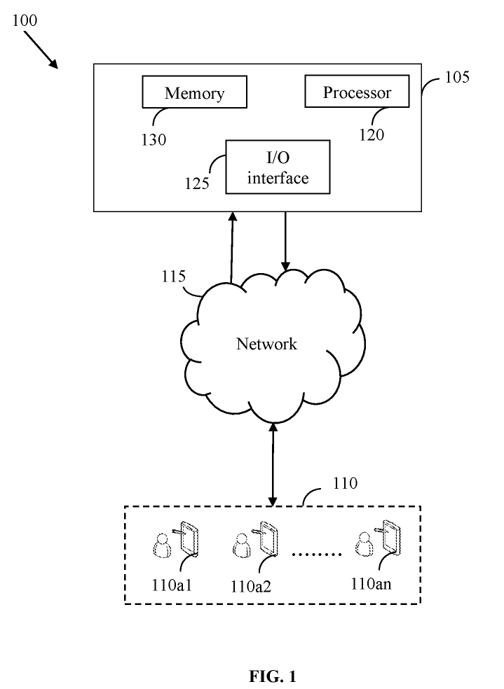

Subsequently, the first user tracks performance of the plurality of second users in executing the tasks within the schedule defined. If the second users complete the tasks within the schedule defined, then the first user assigns reward points to the second user. The reward points obtained by the second user may be converted into monetary value such that the second user will be motivated to perform all other tasks assigned. The various features and embodiments for tracking performance of a plurality of users are explained in conjunction with the description of FIGS. 1-7.

Referring to FIG. 1, an environment 100 of a system 105 for tracking performance of a plurality of users is illustrated, in accordance with various embodiments of the invention. Although the present disclosure is explained by considering that the system 105 is implemented on a server, it may be understood that the system 105 may also be implemented in a variety of computing systems, such as a mainframe computer, a network server, cloud, and the like. It will be understood that the system 105 may be accessed by multiple users through one or more user devices 110a1, 110a2, . . . 110an, collectively referred to as user devices 110 hereinafter, or applications residing on the user devices 110. Examples of the user devices 110 may include, but are not limited to, a portable computer, a personal digital assistant, a handheld device, and a workstation. The user devices 110 are communicatively coupled to the system 105 through a network 115.

In one implementation, the network 115 may be a wireless network, a wired network or a combination thereof. The network 115 can be implemented as one of the different types of networks, such as intranet, local area network (LAN), wide area network (WAN), the internet, and the like. The network 115 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 115 may include a variety of network devices, including routers, bridges, servers, computing devices, storage devices, and the like.

In one embodiment, the system 105 may include at least one processor 120, an input/output (I/O) interface 125, and a memory 130. The at least one processor 120 may be implemented as one or more microprocessors, microcomputers, microcontrollers, digital signal processors, central processing units, state machines, logic circuitries, and/or any devices that manipulate signals based on operational instructions. Among other capabilities, the at least one processor 120 is configured to fetch and execute computer-readable instructions or program instructions stored in the memory 130.

The I/O interface 125 may include a variety of software and hardware interfaces, for example, a web interface, a graphical user interface, and the like. The I/O interface 125 may allow the system 105 to interact with a user directly or through the user devices 110. Further, the I/O interface 125 may enable the system 105 to communicate with other computing devices, such as web servers and external data servers (not shown). The I/O interface 125 may facilitate multiple communications within a wide variety of networks and protocol types, including wired networks, for example, LAN, cable, etc., and wireless networks, such as WLAN, cellular, or satellite. The I/O interface 125 may include one or more ports for connecting a number of devices to one another or to another server.

The memory 130 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

In one embodiment of the invention, users of the user devices 110 may access the system 105 via the I/O interface 125. The system 105 may be used for tracking performance of a plurality of users. The users may comprise at least one first user and one or more second users. Now referring to FIG. 1, the first user device 110a1 may be used by at least one first user. The first user may include, but not limited to, a father, a parent, a teacher, an employer and so on. The second users may include, but not limited to, a mother, a child, a student, an employee and so on. For the purpose of explanation, the second user device 110a2 may be used by a second user i.e., mother. Further, the user device 110a3 may be used by a second user i.e., child. However, it should be understood that when the user device 110a1 may be used by a teacher. In such a case, students may use the second user devices 110a2 and 110a3. Similarly, the employer may use the first user device 110a1. Correspondingly, employees would use the second user devices 110a2 and 110a3.

At first, the first user may use the first user device 110a1 to create his profile. In order to create the profile, the first user provides name, address, contact number and other details. After creating the profile, the first user may create a group in order to add one or more second users. For example, father may create the profile. Subsequently, father may create a group e.g., family. In the family group, the father may add second users e.g., mother and a child. As explained above, each of the first user and the second users uses the first user device 110a1 and the second user devices 110a2 and 110a3 respectively to access the system 105.

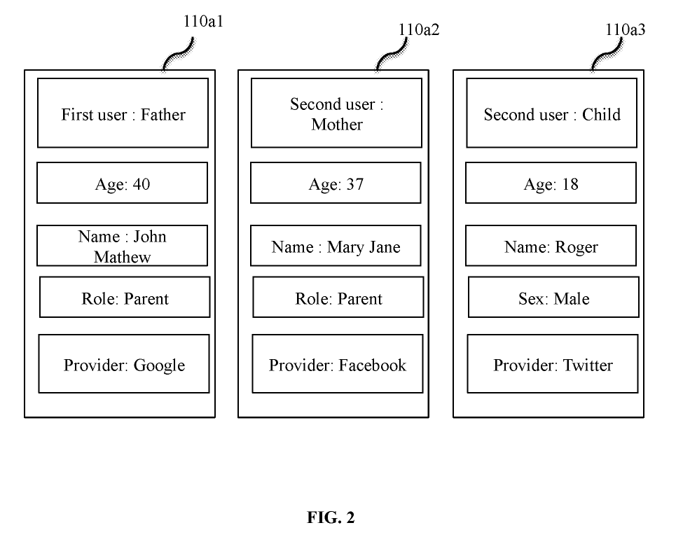

Now referring to FIG. 2, the first user creating family group is explained. As can be seen in FIG. 2, the first user creates his profile using the first user device 110a1. For instance, the father may create by providing Name, age, and role. The role may be a parent's role, child role. Further, the first user may define a medium to access the system 105. For example, the first user may determine that he can access the system 105 using his email ID. In another example, the first user may determine that he may access the system 105 using social media profiles such as Twitter™, Microsoft, Google™, Facebook™, Linkedin™ and so on. After creating the profile, the first user creates a group in order to add other second users. For example, the first user may add a group i.e., family. In the family group, he may add one or more second users. Considering that the first user adds mother and child, for each of the second users, the first user provides details. For example, the first user adds the details of the mother such as Age, Name, Role, and a social media with which she can access the system 105. After adding the details, a notification is sent to the second user device 110a2 indicating that her profile is created under family group. Similarly, first user adds the details of the child such as Age, Name, Role, Sex, and a social media with which he/she can access the system 105. After adding the details, a notification is sent to the second user device 110a3 indicating that his profile is created under family group, as shown in FIG. 2. The first user provides unique names to the second users for ease of identification. After creating the group and adding the second users, the first user may assign a budget for the group. For example, the first user e.g., the father may assign a budget of 150 dollars to the family group. It should be understood that the first user might add or delete second users or even delete the group based on the requirement.

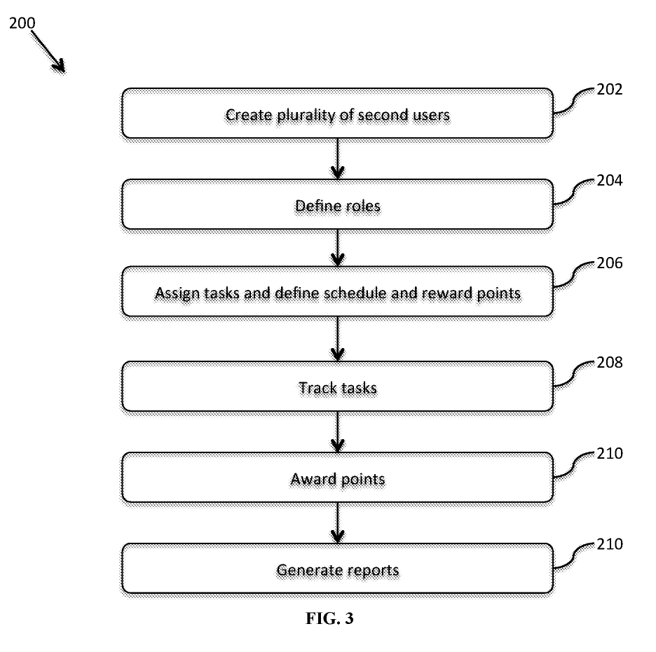

After creating the group and adding details of the second users, the system automatically generates and assigns a plurality of task generated based on the age of the first user and the second users or optionally the first user may customize and assign the tasks for the plurality the second users. The customization may be adding of a new task, deleting an existing task, or adjusting selected parameters associated with the task which the first user is allowed to modify. In an embodiment, once the tasks are automatically generated by the system, some selected parameters of the tasks like Group name, task type, frequency or schedule and unit type may not be allowed to be modified, however, parameters like points of increment, Min Time and Max Time to perform the task may be modified by the first user. The points are given to the second user performing the task based on the point of increment set by system or as modified by the first user. For example, for a group say: Health, and Task type say: Fruit eating, the Min may be set to ‘0’ and Max may be set to ‘3’ with increment of 1, so that the second user performing the task can update the record from 0 to 3 in the step of 1, if the second user updates record with at least one fruit being ate by him/her then he would be eligible for the points. Although, generation and assignment of tasks to each of the second users is explained above with respect to the age factor of the users, it should be understood that other criteria like geographical locations, Sex etc can also be considered alone or in combination thereof. Referring to FIG. 3, a method 200 of assigning tasks and defining schedule and reward points for second users by the system is explained.

At step 202, the first user creates profile for the plurality of second users. As specified above, the first user may create the second user profiles such as mother and child.

At step 204, the first user may define roles for each of the second users. For example, the first user may define role of the mother as parent and role of children as child. Subsequently, the first user may define sex of the child e.g., male or female.

At step 206, the system then generates and assigns the tasks to the first user and each of the second users based on the age of the first user and the second users. Optionally, the first user may be enabled to customize the assigned task for the second users or may be enabled to generate a new task and assign the newly generated task to the second user. For example, the first user may customize and assign task i.e., chores to mother. In addition, the first user may customize the task assigned (say delete the task) and assign new task with group as fitness to mother. Similarly, the first user may delete any assigned task to the child and assign new task i.e., chores to the child. Further, the first user may provide description of the tasks that will enable the second users to understand the tasks assigned to them. It should be understood that the system might assign one or more tasks to each user. Similarly, a single task may be assigned to two or more second users based on the age of the second users and the first user. According to some embodiment, the tasks may be assigned based on the geographical locations of the second users and the first user. According to the embodiment, the different, groups that are considered for assignment are health, education, fitness, Chores, behavior, however, these group examples should be considered as exemplary and one skilled in the art should understand that there may be other group categories that can be added for implementing the current invention.

After assigning the tasks, the system 105 may define a schedule or frequency within which the second user is expected to complete the task. For the above example, the system may define a schedule of one week to the mother to complete the task such as chores. Similarly, the system may define the schedule for the child to complete the tasks assigned. Apart from schedule, the system also defines unit type based on the type of group and task. Further, for each of the task assigned, the first user may be enabled to define a reward point that will be awarded to the second user. The reward point will be given to the second user if the second user completes the task within the schedule defined. In one example, the first user may determine one reward point will be awarded to mother if she completes the task within the schedule defined for the tasks, say chores. Further, additional reward points may be awarded to the second user if the second user completes the task before the schedule. Similarly, the first user may determine that two reward points will be awarded to the child if he completes his task i.e., education within the schedule defined Like the modification of reward points which can be modified for the tasks by the first user, the first user may also be enabled to modify some other parameters associated with the tasks like Min time and Max time to complete the task assigned to the second user.

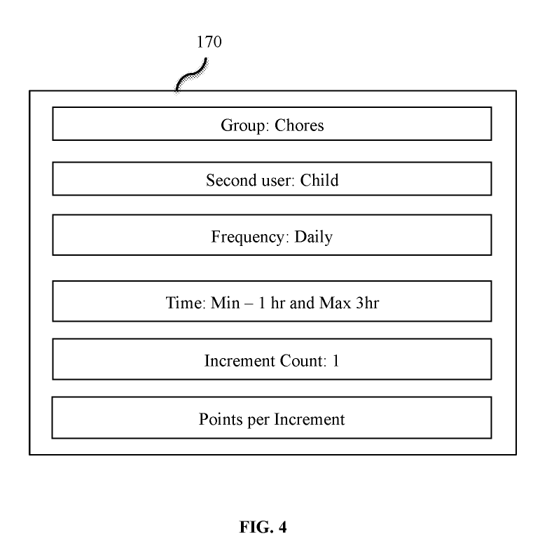

Now referring to FIG. 4, an exemplary implementation of assigning tasks and defining schedule and reward points to second user. Specifically, the FIG. 4 illustrates a screenshot 170 of the first user device 110a1 defining schedule and reward points for the second user is shown. As can be seen in the example from the FIG. 4, the child is added in the group chores. The system defines the frequency in which the child has to perform the tasks is specified. In the example presented, the child is assigned the task of chores to be performed daily. Further, time that the child should perform the task i.e., daily, weekly or monthly is specified. Furthermore, minimum unit by which the task is recorded by the system 105 is specified. The minimum unit by which the task is recorded is referred as increment henceforth. Subsequently, reward points for each increment are defined for the task by the system, however this incremental count can be edited by the firs user if the first user wish to do so. For example, for a single increment three reward points may be assigned. Using above example, if the increment count becomes two, then six reward points will be assigned to the second user.

Referring back to FIG. 3, at step 208, the system 105 tracks the tasks assigned to the second users. In order to explain tracking of the tasks assigned, an example may be used. Consider that the child is assigned the task of chores for a schedule of 30 days for which the task has to be performed everyday. The child updates the record in the system 105 on a daily basis. On any given day within the month or after completion of the month, the first user may check status of the task completion. The first user may check the status to monitor performance of the second user performing the tasks. If the second user has completed the tasks within 30 days, then the system 105 may award reward points to the child if the first user has approved the task done by the second user.

At step 210, after completion of the schedule defined for the tasks, the system 105 may generate reports illustrating performance of the second users. The performance report of the second user can be viewed by the first user or the second user anytime for any specific previous month or for one or more previous months. The generation of reports is explained in the subsequent paragraphs.

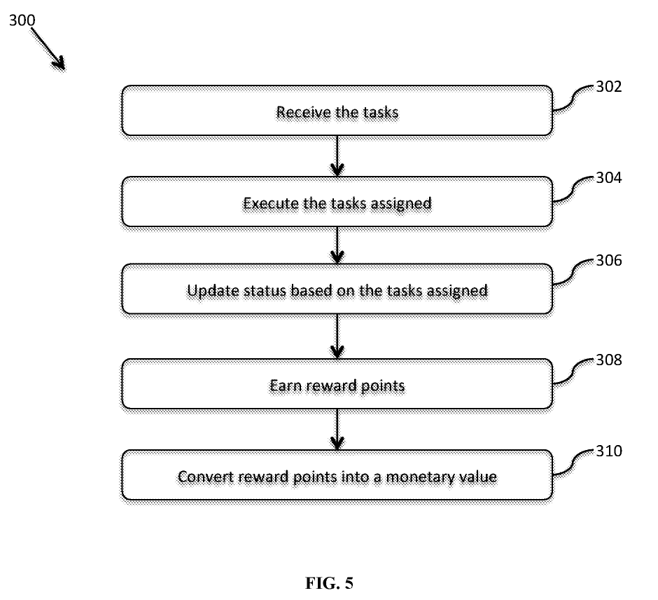

Now referring to FIG. 5, a method 300 an exemplary implementation of performing tasks and updating the details on the system 105 by the second users is shown.

At step 302, the second user e.g., the child receives the tasks assigned by the first user i.e., the father or the child receives the task generated and assigned by the system. In order to access the system 105, the second user may use the second user device say 110a3. The second user may use his Google profile to access the system 105. As presented above, the tasks may be assigned by defining the schedule by the system. For example, the tasks such as chores may be assigned which the child should perform for a period of one month. For example, the child may have to perform the tasks everyday.

At step 304, the child may execute or perform the tasks.

At 306, the child may update status of each task assigned on a daily basis, or weekly. As specified above, the child may use the second user device 110a3 to update the status. At the time of updating the status, the child may provide comments with respect to the tasks assigned. However, the child may not be able to change any tasks or frequency defined by the first user.

At 308, after updating the status, the first user checks the performance of the second user based on the tasks completed by the second user. The first user may approve or disapprove and provide comments with respect to the task. Further, the first user may award reward points to the second user.

At step 310, the second user may convert the reward points earned in to a monetary value. For example each reward point may be converted into one dollar.

After the second user updates the status, the first user may approve or disapprove the tasks completed by the second users. At anytime, the first user may modify the parameters like points of increment or scheduled time limit if the second user is not performing the tasks as per the schedule defined. Further, the parents i.e., father or mother may modify the tasks assigned to the second users i.e., child.

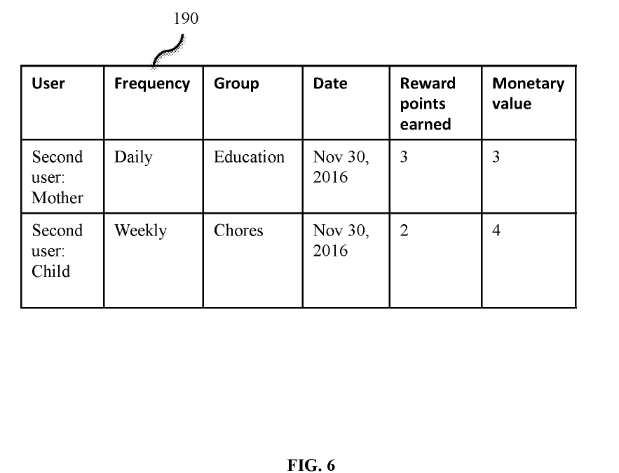

Now referring to FIG. 6, a screenshot 190 illustrating the report generated which shows the details of the tasks performed by the second users in the group. As can be seen from the FIG. 6, the tasks assigned in various groups i.e., education and chores to mother and child respectively. For each of the second user, the reward points earned and the monetary value converted from the reward points is shown. The first user may request the system 105 to generate the report every week or month. Based on the report, the system 105 may generate bar graphs, pie charts and other representations to show the performance of the second users. The report may be generated for the total reward points earned by the second users. The performance report of the second user can be generated for review by the first user for any specific month or one or more previous months, as needed.

The system 105 is used to track the performance of the second users and reward them based on their performance. Further, the reward points are awarded in order to motivate the second users.

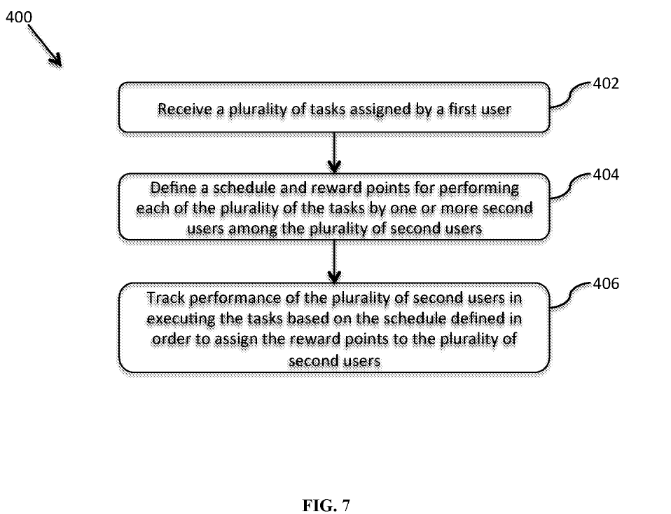

Referring now to FIG. 7, a method 400 for tracking performance of a plurality of users is shown, in accordance with an embodiment of the present disclosure. The method 400 may be described in the general context of computer executable instructions. Generally, computer executable instructions may include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described and is not intended to be construed as a limitation, and any number of the described method blocks can be combined in any order to implement the method 400 or alternate methods. Additionally, individual blocks may be deleted from the method 400 without departing from the spirit and scope of the disclosure described herein. Furthermore, the method may be implemented in any suitable hardware, software, firmware, or combination thereof. However, for ease of explanation, in the embodiments described below, the method 400 may be implemented in the above-described system 105.

At step 402, a plurality of tasks is generated by the system or a plurality of tasks which are generated or existing tasks customized by a first user for the second user is received by the system. The plurality of these is assigned to a plurality of second users based on the age of the first user and each the second users.

At step 404, a schedule and reward points for performing each of the plurality of the tasks by one or more second users among the plurality of second users is defined.

At step 406, performance of the plurality of second users in executing the tasks is tracked. The performance is tracked based on the schedule defined in order to assign the reward points to the plurality of second users. According to the embodiment, the second user is enabled to update the tasks assigned in the current and previous month; however it should be understood by those skilled in the art that the system can be configured to enable the second users to update the status of tasks for any period of time.

Although embodiments of the system tracking performance of a plurality of users have been described in language specific to features and/or methods, it is to be understood that the description is not necessarily limited to the specific features or methods described. Rather, the specific features and methods are disclosed as examples of implementations of a system for tracking performance of a plurality of users.

What is claimed is:

1. A method of tracking performance of a plurality of users, the method comprising:
generating, by a processor, a plurality of tasks, wherein the plurality of tasks are generated based on a profile of each of a plurality of second users created by a first user, wherein the plurality of tasks are assigned to each of the plurality of second users;
defining, by the processor, a schedule and reward points for performing each of the plurality of the tasks by one or more second users among the plurality of second users; and
tracking, by the processor, performance of the plurality of second users in executing the tasks, wherein the performance is tracked based on the schedule defined in order to assign the reward points to the plurality of second users.

2. The method of claim 1, further comprising receiving and assigning, by the processor, the plurality of tasks customized by the first user for the second user.

3. The method of claim 1, wherein the profile of the plurality of second users created by the first user comprising of a predefined age; and a geographical location.

4. The method of claim 1, further comprising providing description for each task to be performed by the plurality of second users.

5. The method of claim 1, further comprising defining occurrence of the tasks within the schedule to track the performance of the plurality of second users.

6. The method of claim 1, further comprising approving or disapproving the tasks completed by the plurality of second users by the first user.

7. The method of claim 5, further comprising enabling the first user for modifying the schedule and the description, within the schedule defined to other second users.

8. The method of claim 1, further comprising converting the reward points into a monetary value.

9. A system for tracking performance of a plurality of users, the system comprising:
a processor; and
a memory, coupled to the processor, wherein the memory comprises program instructions to be executed by the processor, to:
generate a plurality of tasks, wherein the plurality of tasks are generated based on a profile of each of a plurality of second users created by a first user, wherein the plurality of tasks are assigned to each of the plurality of second users;
define a schedule and reward points for performing each of the plurality of the tasks by one or more second users among the plurality of second users; and
track performance of the plurality of second users in executing the tasks, wherein the performance is tracked based on the schedule defined in order to assign the reward points to the plurality of second users.

10. The system of claim 9, wherein the processor executes the program instructions to facilitate receiving and assigning of the plurality of tasks customized by the first user for the second user

11. The method of claim 9, wherein the profile of the plurality of second users created by the first user comprising of a predefined age; and a predefined geographical location.

12. The system of claim 9, wherein the processor executes the program instructions to facilitate defining occurrence of the tasks within the schedule to track the performance of the plurality of second users.

13. The system of claim 9, wherein the processor executes the program instructions to approve or disapprove the tasks completed by the plurality of second users by the first user.

14. The system of claim 12, wherein the processor executes the program instructions to enable the first user for modifying the schedule and the description, within the schedule defined to other second users.

15. The system of claim 9, wherein the processor executes the program instructions to convert the reward points into a monetary value.

16. A non-transitory computer readable storage medium comprising program instructions which, when executed, are configured to perform a method for tracking performance of a plurality of users, the method comprising:
generating, a plurality of tasks, wherein the plurality of tasks are generated based on a profile of each of a plurality of second users created by a first user, wherein the plurality of tasks are assigned to each of the plurality of second users;
defining a schedule and reward points for performing each of the plurality of the tasks by one or more second users among the plurality of second users; and
tracking performance of the plurality of second users in executing the tasks, wherein the performance is tracked based on the schedule defined in order to assign the reward points to the plurality of second users.

17. The method of claim 16, wherein the profile of the plurality of second users created by the first user comprising of a predefined age; and a predefined geographical location.

18. The method of claim 16, further comprising receiving and assigning, by the processor, the plurality of tasks customized by the first user for the second user.

19. The method of claim 16, further comprising providing description for each task to be performed by the plurality of second users.

20. The method of claim 16, further comprising defining occurrence of the tasks within the schedule to track the performance of the plurality of second users.
